(19) United States
(12) Patent Application Publication
(10) Pub. No.: US 2025/0280230 A1
(43) Pub. Date: Sep. 4, 2025

(54) ELECTRONIC DEVICE WITH ACOUSTIC LOCATING CAPABILITIES

(71) Applicant: Apple Inc., Cupertino, CA (US)

(72) Inventors: Daniela M. Deschamps, Palo Alto, CA (US); Tyler S. Atura Bushnell, San Francisco, CA (US); Ruchir M. Dave, San Jose, CA (US); Nikolas T. Vitt, Boulder, CO (US); Rebecca J. Russell, Cupertino, CA (US)

(21) Appl. No.: 18/592,375

(22) Filed: Feb. 29, 2024

(51) Int. Cl. H04R 1/32; G08B 3/10; G08B 25/01; H04W 4/021

(52) U.S. Cl. CPC H04R 1/326; G08B 3/1016; G08B 25/016; H04W 4/021

(57) ABSTRACT

Electronic devices including speakers and microphones for performing locating and tracking are disclosed. In at least one example, an electronic device includes a sensor configured to generate a signal, a speaker configured to generate an auditory alert, a processor in electronic communication with the sensor and the speaker, and a memory in electronic communication with the processor. The memory device can include electronic instructions encoded thereon which, when executed by the processor, cause the processor to perform a method including monitoring the signal, determining whether the signal meets a threshold, and generating the auditory alert in response to the signal meeting the threshold and the electronic device being outside a network area.

### FIELD

The described embodiments relate generally to electronic devices, such as wearable electronic devices. More particularly, the present embodiments relate to wearable electronic devices that include speakers and microphones that emit and receive acoustic alerts that can be used to locate the wearable electronic devices relative to one another.

### BACKGROUND

Electronic devices are increasingly being designed with device portability in mind, for example, to allow users to use these devices in a wide variety of situations and environments. In the context of wearable devices, these devices can be designed to include many different functionalities and to be operated in many different locations and environments. The components of an electronic device, for example, the processors, memory, antennas, display, and other components can partially determine a level of performance of the electronic device. Further, the arrangement of these components with respect to one another in the device can also determine the level of overall performance of the electronic device.

Continued advances in electronic devices and their components have enabled considerable increases in performance. However, while some components can achieve high levels of performance in some situations, the inclusion of multiple components in devices sized to enhance portability can limit the performance of the components, and thus, the performance of the device. Consequently, further tailoring and arrangement of components for electronic devices to provide additional or enhanced functionality, without introducing or increasing undesirable device properties, can be desirable.

### SUMMARY

In at least one example of the present disclosure, an electronic device includes a sensor configured to generate a signal, a speaker configured to generate an auditory alert, a processor in electronic communication with the sensor and the speaker, and a memory device in electronic communication with the processor. The memory device includes electronic instructions encoded thereon which, when executed by the processor, cause the processor to perform a method including monitoring the signal, determining whether the signal meets a threshold, and generating the auditory alert in response to the signal meeting the threshold and the electronic device being outside a network area.

In some examples, the speaker can be configured to generate the auditory alert at a frequency detectable by a human ear or a microphone at 600 ft. In some examples, a value of the threshold can vary based on an activity type selected for the electronic device or based on a health condition of a user of the electronic device.

In some examples, the sensor can be configured to monitor at least one of a vital sign, a movement, a position, or an orientation of a user of the electronic device. In some examples, the sensor can be configured to monitor an environment surrounding the electronic device. In some examples, the auditory alert can include an audible or encoded message including information corresponding to a condition of the electronic device or a user of the electronic device.

In some examples, the auditory alert can be generated automatically in response to the signal meeting the threshold of the triggering event or can be generated in response to a user action subsequent to the signal meeting the threshold of the triggering event.

In at least one example of the present disclosure, an electronic device a microphone, a display, a processor in electronic communication with the microphone and the display, and a memory in electronic communication with the processor. The memory includes electronic instructions encoded thereon which, when executed by the processor, cause the processor to perform a method including detecting an auditory alert with the microphone, and based on the detected auditory alert, displaying a notification on the display indicating an origination direction of the auditory alert relative to the electronic device.

In some examples, the microphone can include a plurality of microphones. In some examples, the method can further include determining the origination direction of the auditory alert relative to the electronic device based on a timing of the plurality of microphones detecting the auditory alert.

In some examples, the method can further include displaying a notification on the display of the electronic device indicating a distance between an origination of the auditory alert and the electronic device. In some examples, the method can further include determining the distance between the origination of the auditory alert and the electronic device based on a volume level of the auditory alert detected by the microphone. In some examples, the method can further include determining the distance between the origination of the auditory alert and the electronic device based on frequencies of the auditory alert detected by the microphone.

In some examples, the method can further include displaying directions on the display of the electronic device to locate an origination of the auditory alert in response to detecting the auditory alert.

In some examples, the detected auditory alert can include an encoded message. The method can further include decoding the encoded message. The encoded message can include at least one of location data of another electronic device, status data of a user of the other electronic device, status data of an environment of the other electronic device, or instructions to be performed by a user of the electronic device.

In at least one example of the present disclosure, a method includes generating a first auditory alert with a first device, detecting a second auditory alert with the first device, and in response to detecting the second auditory alert, generating a third auditory alert with the first device different from the first auditory alert.

In some examples, at least one of the first auditory alert, the second auditory alert, or the third auditory alert can include an audible message or an encoded message. In some examples, the audible message or the encoded message can include at least one of location data of the first device or a second device, status data of a status of a user of the first device or the second device, status data of an environment surrounding the first device or the second device, or instructions to be performed by the user of the first device or the second device.

In some examples, the second auditory alert can be generated by a second device in response to the second device detecting the first auditory alert. In some examples, the first auditory alert can be generated with less power relative to the third auditory alert. In some examples, the method can further include performing digital signal processing with the first device to optimize detection of the second auditory alert.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a perspective view of a wearable electronic device.

FIG. 1B shows a top perspective view of a portion of the wearable electronic device of FIG. 1A.

FIG. 1C shows a bottom perspective view of a portion of the wearable electronic device of FIG. 1A.

FIG. 2A shows a perspective view of a wearable electronic device.

FIG. 2B shows a perspective view of the wearable electronic device of FIG. 2A.

FIG. 2C shows an exploded view of the wearable electronic device of FIG. 2A.

FIG. 3 shows a top-down view of a portion of a wearable electronic device.

FIG. 4A shows a top-down view of a display of a wearable electronic device.

FIG. 4B shows a top-down view of the display of the wearable electronic device of FIG. 4A.

FIG. 5 shows a flow chart of a method of locating an electronic device.

FIG. 6 shows a flow chart of a method of guiding an electronic device to another electronic device.

FIG. 7 illustrates a flow chart of a method of triggering an alert on an electronic device.

FIG. 8 illustrates a block diagram of a computing system.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure generally relates to electronic devices. More particularly, the present disclosure relates to wearable and portable electronic devices. The wearable electronic devices of the present disclosure include tailored arrangements of components to provide additional or enhanced functionality, without introducing or increasing undesirable device properties or performance. In this way, more functionality and componentry can be included in wearable devices for users to wear and operate in any condition or activity without limiting the functionality and durability of the devices.

In some examples, the wearable electronic devices can include components that can be used to generate and detect alerts, such as acoustic alerts. The alerts can be used to provide location and tracking services through the wearable electronic devices, even when the wearable electronic devices are located in areas that do not have network services (e.g., areas outside of cellular, Wi-Fi, and other network services). For example, a wearable electronic device can include a speaker that can generate an acoustic alert that can be heard by humans, other animals, and/or detected by microphones from a distance. The wearable electronic device can further include a microphone that can detect an acoustic alert generated by another electronic device at a distance. The microphone can provide a user of the wearable electronic device with directions for locating or otherwise responding to a detected acoustic alert. The directions can include a distance between the wearable electronic device and the other electronic device; a direction of the other electronic device relative to the wearable electronic device; details regarding a status of a user of the other electronic device or an environment of the other electronic device; and the like. By generating and detecting acoustic alerts, the wearable electronic device can facilitate tracking and locating services, even when the wearable electronic device is located in areas without access to network services (e.g., in areas without access to cellular networks, Wi-Fi networks, and the like).

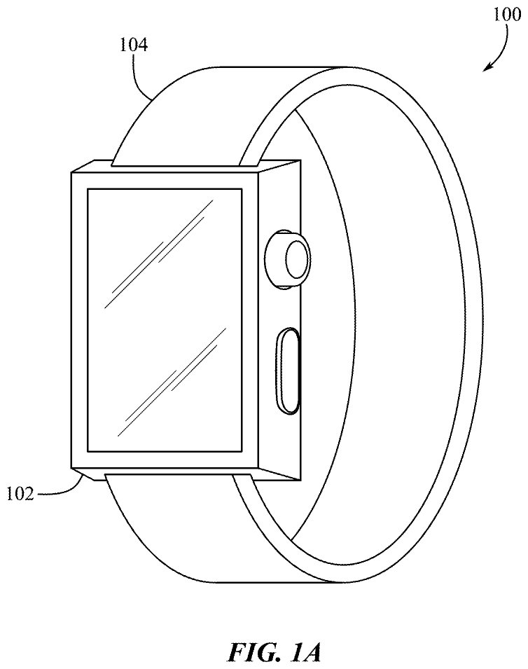

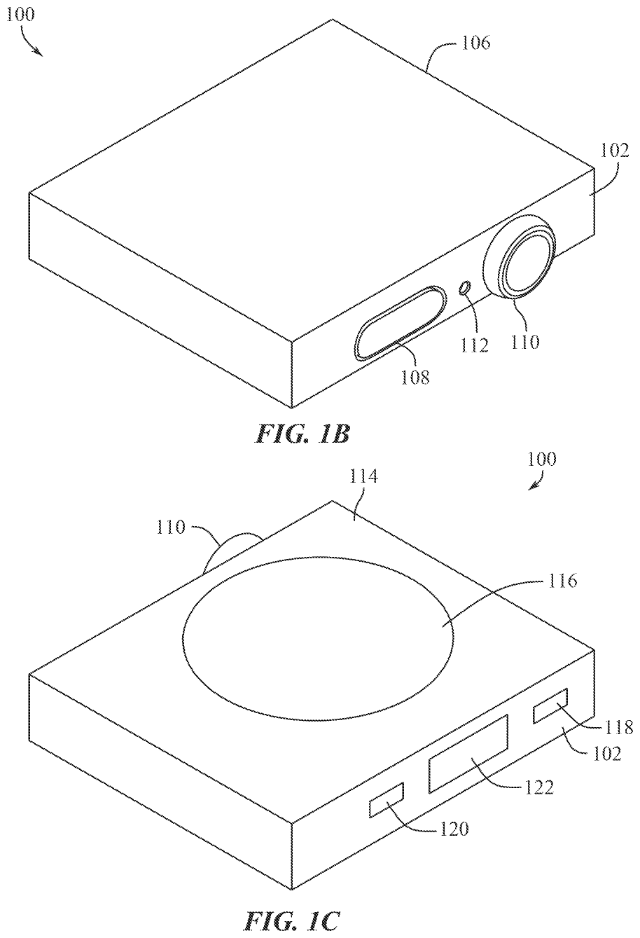

These and other embodiments are discussed below with reference to FIGS. 1A through 7. However, those skilled in the art will readily appreciate that the detailed description given herein with respect to these figures is for explanatory purposes only and should not be construed as limiting. Furthermore, as used herein, a system, a method, an article, a component, a feature, or a sub-feature comprising at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIGS. 1A through 1C illustrate perspective views of an electronic device 100. As illustrated in FIGS. 1A through 1C, the electronic device 100 can be a watch, such as a smartwatch. However, the electronic device 100 illustrated in FIGS. 1A through 1C is merely one representative example of a device that can be used in conjunction with the systems and methods disclosed herein. The electronic device 100 can correspond to any form of wearable or portable electronic device, such as a portable media player, a media storage device, a portable digital assistant (“PDA”), a tablet computer, a computer, a mobile communication device such as a cellular phone, a GPS unit, a remote control device, a transceiver (e.g., an avalanche transceiver), or another electronic device. The electronic device 100 can be referred to as an electronic device, a consumer device, or the like. In some examples, the electronic device 100 can include a housing 102 that can carry operational components, for example, in an internal volume at least partially defined by the housing 102. The electronic device 100 can also include a strap 104, or other retaining component that can secure the electronic device 100 to a body of a user as desired.

In FIGS. 1B and 1C, the strap 104 has been omitted. As illustrated in FIG. 1B, the electronic device 100 can include a housing 102 and a display assembly 106 attached to the housing 102. The housing 102 and the display assembly 106 can each define at least a portion of an exterior surface of the electronic device 100.

The display assembly 106 can include a glass, a plastic, or any other substantially transparent exterior layer, material, component, or assembly. The display assembly 106 can include multiple layers, with each layer providing a unique function, as described herein. The display assembly 106 can be, or can be a part of, an interface component of the electronic device 100. The display assembly 106 can define a front exterior surface of the electronic device 100. The surface defined by the display assembly 106 can be considered an interface surface. In some examples, the interface surface defined by display assembly 106 can receive inputs, such as touch inputs, from a user.

In some examples, the housing 102 can be a substantially continuous or unitary component and can define one or more openings to receive components of the electronic device 100. In some examples, the electronic device 100 can include input components such as one or more buttons 108 and/or a crown 110 that can be disposed in the openings defined in the housing 102. In some examples, a material can be disposed between the buttons 108 and/or crown 110 and the housing 102 to provide an airtight and/or watertight seal at the locations of the openings. The housing 102 can also define one or more openings or apertures, such as aperture 112 that can allow for sound to pass into or out of the internal volume defined by the housing 102. For example, the aperture 112 can be in communication with a microphone component disposed in the internal volume. In some examples, the housing 102 can define or include a feature, such as an indentation to removably couple the housing 102 and a strap or retaining component (e.g., the strap 104 of FIG. 1A).

FIG. 1C illustrates a bottom perspective view of the electronic device 100. The electronic device 100 can include a back cover 114 that can be attached to the housing 102, for example, opposite the display assembly 106. The back cover 114 can include ceramic, plastic, metal, or combinations thereof. In some examples, the back cover 114 can include an at least partially electromagnetically transparent component 116. The electromagnetically transparent component 116 can be transparent to any desired wavelengths of electromagnetic radiation, such as visible light, infrared light, radio waves, or combinations thereof. In some examples, the electromagnetically transparent component 116 can allow sensors and/or emitters disposed in the housing 102 to communicate with the external environment. Together, the housing 102, the display assembly 106 and the back cover 114 can substantially define an internal volume and an external surface of the electronic device 100.

The housing 102 can further define one or more openings to receive components of the electronic device 100 in a sidewall opposite a sidewall in which the button 108 and the crown 110 are disposed. For example, as illustrated in FIG. 1C, the electronic device 100 can include a first speaker vent 118, a second speaker vent 120, and a button 122 disposed between the first speaker vent 118 and the second speaker vent 120. The first speaker vent 118 and the second speaker vent 120 can provide fluid communication from a common speaker volume behind one or more speakers and the sidewall of the housing 102 (e.g., within an internal volume defined by the housing 102) to the external environment. The button 122 can be disposed between the first speaker vent 118 and the second speaker vent 120 to save space and provide a compact design without interrupting the functionality of the one or more speakers communicating with the external environment through the first speaker vent 118 and the second speaker vent 120.

Although one speaker disposed adjacent to the first speaker vent 118 and the second speaker vent 120 and one microphone disposed adjacent to the aperture 112 have been discussed with reference to FIGS. 1A through 1C, the electronic device 100 can include any number of speakers and microphones. The speakers of the electronic device 100 can be used to generate acoustic alerts, which can be used to locate the electronic device 100. The microphones can be used to detect or receive acoustic alerts generated by other electronic devices, which can be used to locate the other electronic devices using the electronic device 100.

The electronic device 100 can include one or more speakers, which can be used to generate an acoustic alert. For example, the speakers of the electronic device 100 can generate an acoustic alert that can be heard by people and/or microphones of other electronic devices at a distance ranging from about 0 ft. to about 600 ft., a distance of up to about 500 ft., up to about 800 ft., up to about 1,000 ft., up to about 1,200 ft., or the like. The speakers of the electronic device 100 can be tuned to generate acoustic alerts at frequencies that can be heard by humans, other animals (e.g., search and rescue dogs or the like), and/or microphones of other electronic devices at a long range, up to a maximum range, such as up to about 500 ft., up to about 600 ft., up to about 800 ft., up to about 1,000 ft., up to about 1,200 ft., or the like. The speakers of the electronic device 100 can generate acoustic alerts based on a command from a user of the electronic device 100 or based on a triggering event. Triggering events can include detected conditions of the user based on sensor or other data, detected conditions of the environment surrounding the electronic device 100 based on sensor or other data, a signal received by the electronic device 100, and the like.

The electronic device 100 can include one or more microphones, which can be used to detect an acoustic alert generated by another electronic device. The microphones of the electronic device 100 can determine a distance between the electronic device 100 and the other electronic device (e.g., a distance between the electronic device 100 and an origination of an acoustic alert) based on a volume level of a detected acoustic alert, specific frequencies present in the acoustic alert detected by the electronic device 100, detectable features of the acoustic alert detected by the electronic device 100, or the like. The electronic device 100 can include a plurality of microphones, and the electronic device 100 can determine a direction of the other electronic device relative to the electronic device 100 (e.g., a direction of an origination of an acoustic alert relative to the electronic device 100) based on a timing of the acoustic alert being detected by each of the microphones of the electronic device 100, or based on a volume level of the acoustic alert being detected by each of the microphones of the electronic device 100. The microphones of the electronic device 100 can operate passively (e.g., can detect an alert anytime the electronic device 100 is powered on), or can operate actively, such as during a time when the electronic device 100 is in a search mode. The microphones of the electronic device 100 can be tuned to enhance or maximize detection of sounds at the same frequencies at which the speakers of other electronic devices generate acoustic alerts, and at frequencies that can travel a maximum or long range, such as up to about 500 ft., up to about 600 ft., up to about 800 ft., up to about 1,000 ft., up to about 1,200 ft., or the like.

The electronic device 100 can be used by users located within a network area or outside of a network area. When the electronic device 100 is located within a network area, the electronic device 100 can access various network services, such as cellular networks, Wi-Fi networks, or the like. When the electronic device 100 is located outside of the network area, the electronic device 100 may not have access to network services, or may have access to limited networks, such as a satellite network. By including speakers and microphones in the electronic device 100 that can generate and detect acoustic alerts, the electronic device 100 can provide location and tracking services in environments outside network areas. As an example, this can be used for search and rescue missions, calls for help, and the like using the electronic device 100, even when the electronic device 100 is located outside network areas.

Any of the features, components, and/or parts, including the arrangements and configurations thereof shown in FIGS. 1A through 1C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 1A through 1C.

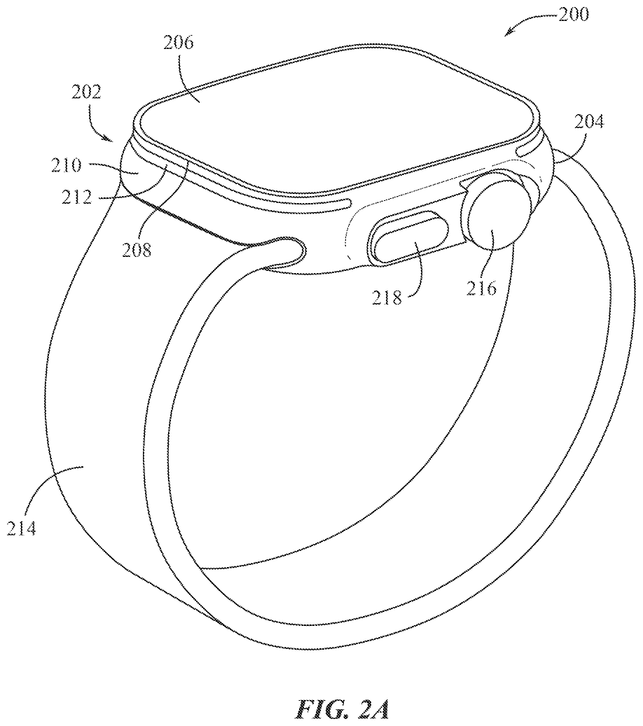

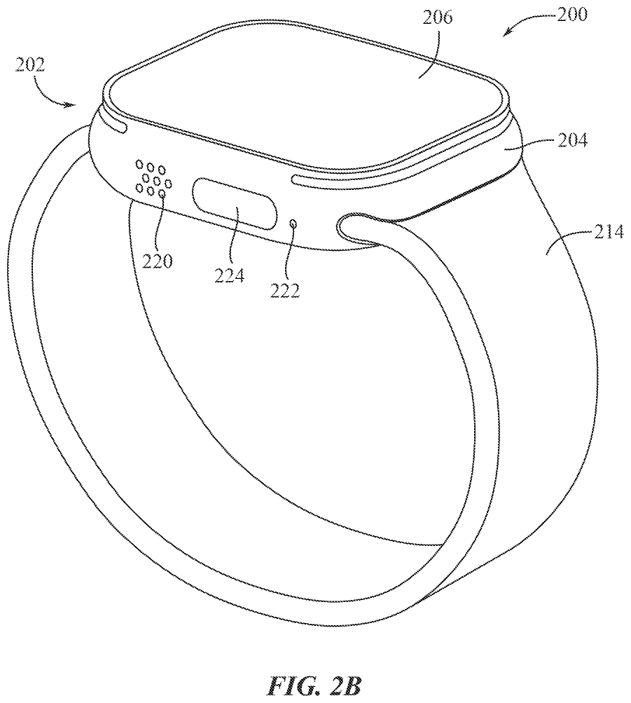

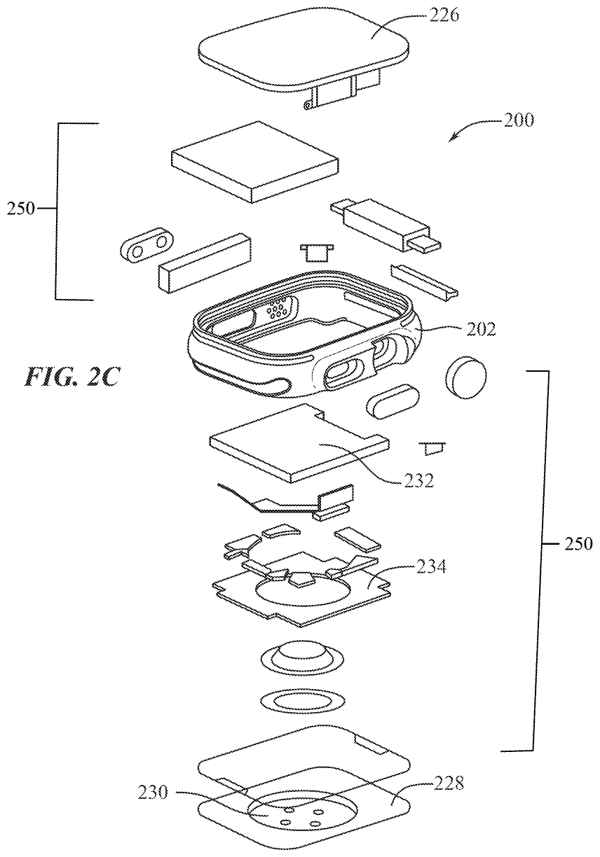

FIGS. 2A and 2B illustrate perspective views and FIG. 2C illustrates an exploded view of a wearable electronic device 200 including a housing 202. The housing 202 includes sidewalls 204 that define an opening in which a display cover 206 is disposed. The sidewalls 204 can include an upper portion 208 defining an upper peripheral edge surrounding the display cover 206, a lower portion 210, and a middle portion 212 disposed between the upper portion 208 and the lower portion 210. The wearable electronic device 200 can include a securement strap 214 configured to secure the wearable electronic device 200 to an appendage of the user. In at least one example, the sidewalls 204 of the housing 202 can define an upper peripheral edge of the wearable electronic device 200 surrounding the display cover 206.

In at least one example, the display cover 206 defines a top surface of the wearable electronic device 200 disposed in a plane. The top surface can include an outward facing surface of the display cover 206. In at least one example, the display cover 206 can be a transparent display cover disposed above or over other display layers. In at least one example, the outward facing surface of the display cover 206 can be planar. The plane can be level/flush with or set below and recessed relative to the upper peripheral edge of the sidewalls 204. In this way, when the wearable electronic device 200 comes into contact with a surface or object at or near the upper surface of the display cover 206 and/or the upper peripheral edge of the sidewalls 204, contact and potential damage to the display cover 206 can be reduced. In one example, the display cover 206 is set flush with or below the upper peripheral edges of the sidewalls 204 to protect the display cover 206 from damage.

In at least one example, as shown in FIG. 2A, the sidewalls 204 can define a first side of the wearable electronic device 200 having a turret or protrusion defining recessed features in which a crown 216 and a button 218 are positioned. The turret can include a protrusion extending from a surrounding surface of the sidewall 204. The crown 216 can be a part of a turn dial button or other functional knob configured to be manipulated by the user. The crown 216 can be disposed in the recessed portion, as noted above, such that the first side of the sidewalls 204 extend outward in a turret configuration and at least partially around the crown 216. In this way, contacts and bumps by other objects against the first side of the sidewall 204 during use can contact the sidewall 204 without pressing or turning the crown 216. In this way, the protrusion and the recessed portion of the first side of the sidewalls 204 can prevent inadvertent manipulation of the crown 216. In at least one example, the protrusion can include a window exposing a circumferential side surface of the crown 216 where a user can manually manipulate the crown 216 within the recess of the turret protrusion. The button 218 shown in FIG. 2A can also be at least partially surrounded by an outwardly extending portion of the sidewall 204, such that the button 218 is disposed within another recess thereof, to protect the button 218 from inadvertent contacts.

In at least one example, as shown in FIG. 2B, the sidewalls 204 can define a second side opposite the first side shown in FIG. 2A. In such an example, the wearable electronic device 200 can include a first speaker vent 220, a second speaker vent 222, and a button 224 disposed within an aperture defined by the sidewalls 204 between the first speaker vent 220 and the second speaker vent 222. The first and second speaker vents 220, 222 can provide fluid communication from a common speaker volume behind the sidewall 204 (e.g., within an internal volume defined by the sidewalls 204) and the external environment. The button 224 can be disposed between the first and second speaker vents 220, 222 to save space and to provide a compact design without interrupting the functionality of the one or more speakers communicating with the external environment through the first and second speaker vents 220, 222.

FIG. 2C illustrates an exploded view of the wearable electronic device 200. The wearable electronic device 200 includes a display assembly 226, a housing 202, a back cover 228, and an electromagnetically transparent component 230. In addition, the exploded view of FIG. 2C illustrates various internal components 250 that may be disposed within an internal volume defined by the housing 202, the back cover 228, the electromagnetically transparent component 230, and the display assembly 226. For example, the wearable electronic device 200 can include one or more printed circuit boards (PCBs) 232 and one or more antenna components 234, electrical connectors and flexes, microphones, buttons, seals, gaskets, memory components, processors, sensors, dials, batteries, and so forth.

Any of the features, components, and/or parts, including the arrangements and configurations thereof shown in FIGS. 2A through 2C can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 2A through 2C.

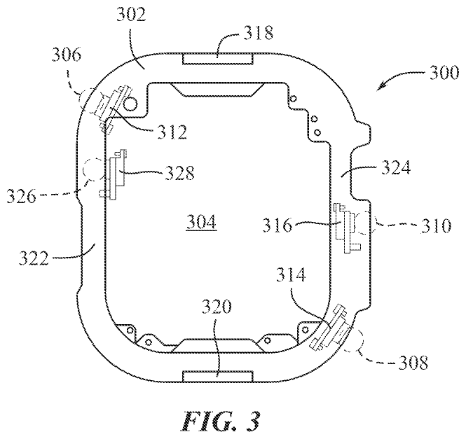

FIG. 3 illustrates a top-down view of a portion of an electronic device 300. The electronic device 300 can be similar to, or the same as, the electronic devices 100, 200, discussed above with respect to FIGS. 1A through 2C. As illustrated in FIG. 3, the electronic device 300 can include a housing sidewall 302 defining an internal volume 304 with the sidewall 302 extending 360-degrees circumferentially around the internal volume 304. The sidewall 302 can define a first aperture 306, a second aperture 308 between about 155-degrees and 205-degrees relative to the first aperture 306, and a third aperture 310 closer to the second aperture 308 than the first aperture 306.

The electronic device 300 can include a first microphone 312 disposed in the internal volume 304 and configured to receive sound through the first aperture 306, a second microphone 314 disposed in the internal volume 304 and configured to receive sound through the second aperture 308, and a third microphone 316 disposed in the internal volume 304 and configured to receive sound through the third aperture 310.

The electronic device 300 can further include a first strap receiving feature 318 and a second strap receiving feature 320 opposite the first strap receiving feature 318. A first sidewall portion 322 can extend between the first strap receiving feature 318 and the second strap receiving feature 320. The first sidewall portion 322 can define the first aperture 306 closer to the first strap receiving feature 318 than the second strap receiving feature 320. A second sidewall portion 324 can be disposed opposite the first sidewall portion 322 and can extend between the first strap receiving feature 318 and the second strap receiving feature 320. The second sidewall portion 324 can define the second aperture 308 and the third aperture 310. The second aperture 308 can be defined closer to the second strap receiving feature 320 than the first strap receiving feature 318.

The electronic device 300 can further include a fourth aperture 326. A speaker 328 can be disposed in the internal volume 304 adjacent the fourth aperture 326. The fourth aperture 326 and the speaker 328 can be defined in the first sidewall portion 322 between the first aperture 306 and the second strap receiving feature 320. The fourth aperture 326 can be disposed closer to the first aperture 306 than the first strap receiving feature 318, the second strap receiving feature 320, the second aperture 308, or the third aperture 310.

In at least one example, the second aperture 308 and the third aperture 310 can be defined on a distal side of the electronic device 300. The distal side of the electronic device 300 can include or be defined by the second sidewall portion 324 where the term “distal” refers to anatomically distal when worn on the wrist of a user. In other words, the distal side of the electronic device 300 includes the side facing the hand of the user when worn. Conversely, the proximal side of the electronic device 300 can include or can be defined by the first sidewall portion 322 where the term “proximal” refers to anatomically proximal when worn on the wrist of the user. In other words, the proximal side of the electronic device 300 includes the side facing the forearm of the user when worn. In at least one example, the first aperture 306 can be defined on the proximal side of the electronic device 300. In some examples, the first microphone 312 can be oriented to receive sound from a first direction and the second microphone 314 can be oriented to receive sound from a second direction different than the first direction. In some examples, the second direction is substantially opposite the first direction. In such an example, the first aperture 306 and the fourth aperture 326 can be defined on a proximal side of the electronic device 300 and the second and third apertures 308, 310 can be defined on a distal side of the electronic device 300.

The speaker 328 can be used by the electronic device 300 to generate an acoustic alert. For example, the speaker 328 can generate an acoustic alert that can be heard by people and/or other electronic devices at a distance ranging from about 0 ft. to about 600 ft., a distance of up to about 500 ft., up to about 800 ft., up to about 1,000 ft., up to about 1,200 ft., or the like. The speaker 328 can be tuned to generate sounds at frequencies that can be detected by humans, search animals, and/or microphones of other electronic devices at a maximum or long range, such as up to about 500 ft., up to about 600 ft., up to about 800 ft., up to about 1,000 ft., up to about 1,200 ft., or the like. The speaker 328 can generate acoustic alerts based on a command from a user, a triggering event, or the like. The triggering event can be based on detected conditions of the user, detected conditions of the environment surrounding the electronic device 300, a signal received by the electronic device 300, or the like. The acoustic alert generated by the speaker 328 can be omnidirectional, or multiple speakers 328 can be included in the electronic device 300 such that the alert is omnidirectional. In some examples, the acoustic alert can be directional or at least partially directional (e.g., can have a greater volume in one direction), and the user of the electronic device 300 can point the electronic device 300 in a desired direction.

The microphones 312, 314, 316 can be used by the electronic device 300 to detect an acoustic alert generated by another electronic device. The acoustic alert generated by the other electronic device can be generated at a specific volume level, and the volume level of an acoustic alert detected by the microphones 312, 314, 316 can be used to determine a distance between the electronic device 300 and the other electronic device. The acoustic alert generated by the other electronic device can include different frequencies that travel different distances, and the frequencies of an acoustic alert detected by the microphones 312, 314, 316 can be used to determine the distance between the electronic device 300 and the other electronic device. Each of the microphones 312, 314, 316 can detect an acoustic alert generated by the other electronic device at a slightly different time, and this timing can be used to determine a direction of the other electronic device relative to the electronic device 300. In some examples, each of the microphones 312, 314, 316 can detect an acoustic alert generated by the other electronic device at a slightly different volume level, and this volume level can be used to determine a direction of the other electronic device relative to the electronic device 300. The microphones 312, 314, 316 can operate passively (e.g., can detect an acoustic alert anytime the electronic device 300 is powered on), or can operate actively, such as when the electronic device 300 is in a search mode.

The speaker 328 and the microphones 312, 314, 316 can be tuned to generate acoustic alerts and detect acoustic alerts at specific frequencies, such as frequencies that coincide with one another. In some examples, the frequencies can be frequencies that can travel long ranges, such as up to about 500 ft., up to about 600 ft., up to about 800 ft., up to about 1,000 ft., up to about 1,200 ft., or the like, to provide tracking and location services in a large area. In some examples, the frequencies can be frequencies that travel better through certain mediums, such as snow, water, or the like. The electronic device 300 can detect the environment surrounding the electronic device 300, or the user of the electronic device 300 can specify the environment surrounding the electronic device 300 in order to provide an acoustic alert that travels optimally through a surrounding medium. This can be beneficial for providing location and tracking services in specific environments, such as outside in the winter or in water.

FIG. 3 illustrates one configuration of the apertures 306, 308, 310, 326, the microphones 312, 314, 316, and the speaker 328 that can be included in an electronic device 300. However, any other configurations are possible. For example, each of the apertures 306, 308, 310, 326, the microphones 312, 314, 316, and the speaker 328 can be disposed anywhere along the sidewalls 302. Moreover, although one speaker 328 and three microphones 312, 314, 316 are described with respect to and illustrated in FIG. 3, any number of speakers and microphones can be included in the electronic device 300. For example, a greater number of speakers and a greater or fewer number of microphones can be included in the electronic device 300. Further, because the microphones 312, 314, 316 and the speaker 328 are disposed on the sidewalls 302 of the electronic device 300, the microphones 312, 314, 316 and the speaker 328 may be configured to preferentially detect acoustic alerts coming from side directions and generate acoustic alerts to side directions. While the electronic device 300 is described as detecting acoustic alerts from various side directions, the electronic device 300 can also include microphones oriented to detect sounds from various orientations, and can include speakers oriented to generate sounds to various orientations, including into and out of the page illustrated in FIG. 3.

Any of the features, components, and/or parts, including the arrangements and configurations thereof shown in FIG. 3 can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIG. 3.

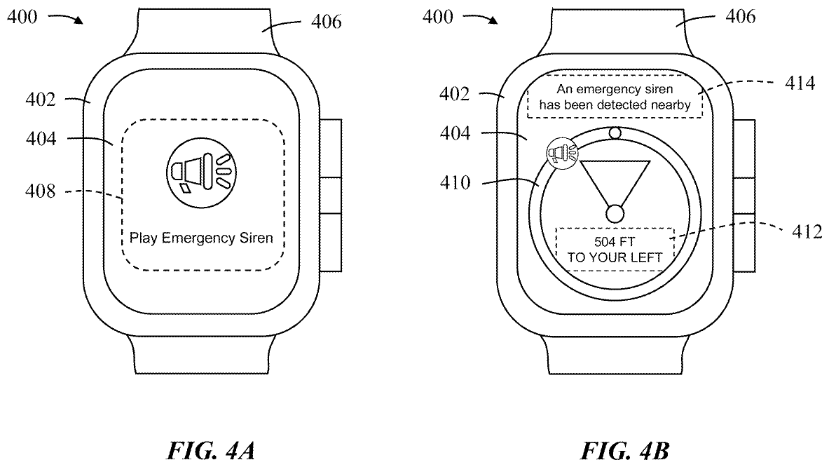

FIGS. 4A and 4B illustrate an electronic device 400 in an alert mode and a search mode, respectively. The electronic device 400 can be similar to or the same as the electronic devices 100, 200, 300 discussed above with respect to FIGS. 1A through 3. As illustrated in FIGS. 4A and 4B, the electronic device 400 can include a housing 402, a display 404, and a strap 406.

In the example of FIG. 4A, a user can command the electronic device 400 to enter an alert mode. In the alert mode, the display 404 can display an alert message 408, which can be used by the user of the electronic device 400 to generate an acoustic alert through a speaker of the electronic device 400. As an example, the user can generate the acoustic alert in an emergency situation, and the acoustic alert can be used to guide bystanders, searchers, or the like to the location of the electronic device 400. The acoustic alert can be used to guide others to the user's location, even when the user and the electronic device 400 are located in remote locations, such as locations that are outside of network areas and do not have access to cellular networks, Wi-Fi networks, and the like.

In the example of FIG. 4B, the electronic device 400 can enter a search mode. The electronic device 400 can enter the search mode automatically, in response to the electronic device 400 detecting an acoustic alert generated by another electronic device, or the electronic device 400 can enter the search mode manually, in response to a command by the user of the electronic device 400. The electronic device 400 can passively detect acoustic alerts, can detect acoustic alerts based on commands from a user, can detect acoustic when the electronic device 400 is in a specified area (e.g., in an area without access to network services, such as cellular networks, Wi-Fi networks, and the like), or the like. In the search mode, the display 404 can display a compass 410, text instructions 412, a search notification 414, and the like, which can be used by the user of the electronic device 400 to locate or otherwise respond to the acoustic alert generated by the other electronic device.

The compass 410 and the text instructions 412 can indicate various instructions to guide the user of the electronic device 400 to the other electronic device. For example, the compass 410 and the text instructions 412 can indicate a direction of the other electronic device relative to the electronic device 400 and a distance between the electronic device 400 and the other electronic device. The compass 410 and the text instructions 412 can further indicate any obstructions, trails, landmarks, or the like between the electronic device 400 and the other electronic device in order to help guide the user of the electronic device 400 to the other electronic device.

The search notification 414 can indicate that an acoustic alert has been detected, and can provide information about the acoustic alert. For example, any information regarding a status of the user of the other electronic device, conditions of the environment surrounding the other electronic device, or the like can be provided to the user of the electronic device 400 through the search notification 414. This information can include a health status of the user of the other electronic device, and instructions for responding to the health status of the user of the other electronic device. This information can further include warnings related to the conditions of the environment surrounding the other electronic device. The search notification 414 can be generated automatically based on the electronic device 400 detecting the acoustic alert generated by the other electronic device. In examples in which the acoustic alert includes encoded information, the search notification can be altered based on the encoded information. For example, the status of the user of the other electronic device or conditions of the environment surrounding the other electronic device can be communicated to the electronic device 400 through an encoded acoustic alert and decoded by the electronic device 400.

In some examples, the electronic devices 100, 200, 300, 400 can further include satellite transmitters and/or receivers, ultra-wideband transmitters and/or receivers, and the like. The satellite transmitters can be used to send emergency signals from the electronic devices 100, 200, 300, 400 when the electronic devices 100, 200, 300, 400 are located in areas outside of network coverage (e.g., in areas outside of cellular networks, Wi-Fi networks, and the like). The satellite transmitters may be used to provide a location of the electronic devices 100, 200, 300, 400 within about 50 feet. The ultra-wideband transmitters and/or receivers can be used to provide a precise location of the electronic devices 100, 200, 300, 400 with a limited range. For example, the ultra-wideband transmitters and/or receivers can provide a location of the electronic devices 100, 200, 300, 400 within about a cm at a range of up to about 50 ft., up to about 100 ft., up to about 150 ft., up to about 200 ft., or the like. The satellite transmitters and/or receivers, ultra-wideband transmitters and/or receivers, and the like can be used in combination with the speakers and the microphones to improve location services of the electronic devices 100, 200, 300, 400 at different ranges, with different levels of precision.

Any of the features, components, and/or parts, including the arrangements and configurations thereof shown in FIGS. 4A and 4B can be included, either alone or in any combination, in any of the other examples of devices, features, components, and parts shown in the other figures. Likewise, any of the features, components, and/or parts, including the arrangements and configurations thereof shown in the other figures can be included, either alone or in any combination, in the example of the devices, features, components, and parts shown in FIGS. 4A and 4B.

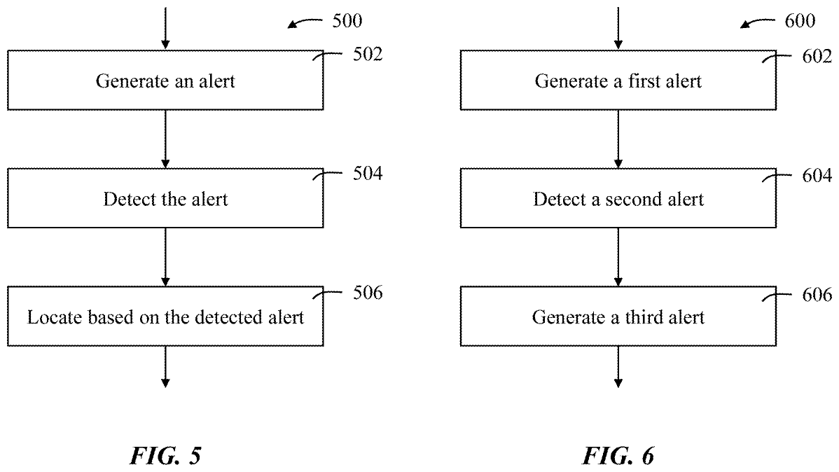

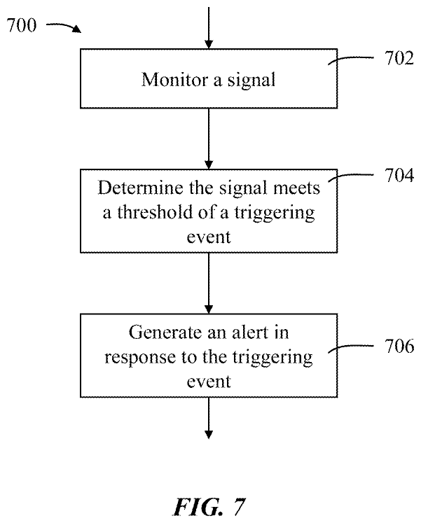

FIG. 5 illustrates a method 500 of locating a first electronic device (alternatively referred to as a first device). The first device can be similar to or the same as the electronic devices 100, 200, 300, 400 discussed above with respect to FIGS. 1A through 4B. In step 502, an acoustic alert is generated. The acoustic alert can be generated by a speaker of the first device. The acoustic alert can be generated in response to a command by a user of the first device, automatically in response to a triggering event (discussed below with respect to FIG. 7), or the like. The triggering event can include a user condition meeting a threshold value (e.g., a detected health condition, a detected accident, or the like), an environmental condition meeting a threshold value (e.g., a detected environmental change, emergency, or disaster), a received signal meeting a threshold value (e.g., receiving a signal reporting an emergency or disaster in proximity to the first device), or the like.

The acoustic alert generated in step 502 can be generated at a maximum volume producible by the speaker of the first device and with a frequency that can be tuned to travel and be heard at long ranges. The frequency of the acoustic alert can be tuned to be heard by human ears, other animal ears (e.g., search and rescue dogs or the like), or the like at a maximum or long range. The frequency of the acoustic alert can be tuned to be detected by a microphone of another electronic device (e.g., a second electronic device or second device) at a maximum or long range. In some examples, the acoustic alert generated by the first device can be audible by humans, animals, and/or microphones of other electronic devices at a distance ranging from about 0 ft. to about 600 ft., a distance of up to about 500 ft., up to about 800 ft., up to about 1,000 ft., up to about 1,200 ft., or the like.

In some examples, the acoustic alert can be generated in step 502 with a specific pattern. For example, the acoustic alert can be generated with a pattern that improves a signal-to-noise ratio of the acoustic alert (e.g., at a maximum length sequence (MLS)), which can improve detection of the acoustic alert by humans, other animals, and/or microphones of other electronic devices. The acoustic alert can include audio messages audible to humans in proximity to the first device. The acoustic alert can include encoded messages that can be decoded by other electronic devices. The audio and/or encoded messages can include information such as a status of the user of the first device, a status of the environment surrounding the first device, information related to a signal received by the first device, or the like.

In step 504, the acoustic alert is detected. In some examples, the acoustic alert can be detected by a human or other animal in proximity to the first device. In some examples, the acoustic alert can be detected by a second device. The second device can be similar to or the same as the electronic devices 100, 200, 300, 400 discussed above with respect to FIGS. 1A through 4B, and can include one or more microphones that can detect the acoustic alert generated by the first device.

In some examples, the microphones of the second device can be tuned to detect the acoustic alert. For example, the acoustic alert can be generated at a prescribed frequency, which the microphones of the second device can be tuned to detect. The microphones can be tuned to detect the acoustic at the prescribed frequency at a maximum range. In some examples, the second device can detect the acoustic alert generated by the first device at a distance ranging from about 0 ft. to about 600 ft., a distance of up to about 500 ft., up to about 800 ft., up to about 1,000 ft., up to about 1,200 ft., or the like. In some examples, the second device can perform digital signal processing in order to focus on the acoustic alert generated by the first device and cancel out background noises and the like. This can improve detection of the acoustic alert by the second device.

In some examples, the second device can generate a notification based on a detected acoustic alert. For example, in examples in which the acoustic alert includes an encoded or audio message, the second device can decode the message and provide a notification to the user of the second device based on the message of the acoustic alert. The notification can be provided by a visual display, an audio message, a tactile message, or the like. The notification can provide the user of the second device with information such as a status of the user of the first device, a status of the environment surrounding the first device, information related to a signal received by the first device, or the like.

In step 506, the first device is located based on the detected acoustic alert. In an example in which the acoustic alert is detected by a human or other animal in proximity to the first device, the human can locate the first device by listening to the acoustic alert and moving towards the acoustic alert. In an example in which the acoustic alert is detected by microphones of a second device, the second device can generate instructions for locating the first device. These instructions can be presented to the user of the second device through auditory, visual, tactile, or any other suitable means. The instructions can include a distance between the second device and the first device; a direction of the first device relative to the second device; landmarks, routes, or the like between the second device and the first device; instructions for responding to the user of the first device or the surroundings of the first device; or the like.

The second device can determine the distance between the second device and the first device by any suitable means. For example, the first device can generate the acoustic alert at step 502 at a prescribed volume level, the second device can determine the volume level of the acoustic alert detected in step 504, and the second device can calculate the distance between the second device and the first device based on the generated and detected volume levels. The first device can generate the acoustic alert at step 502 at prescribed frequencies that travel different distances (e.g., with some frequencies dropping off at certain distances), the second device can determine frequencies present in the acoustic alert detected in step 504, and the second device can calculate the distance between the second device and the first device based on the detected frequencies of the acoustic alert. Environmental conditions such as temperature, humidity, obstructions, and the like can affect the propagation of sound waves, and the second device can use any known conditions to better estimate the distance between the second device and the first device.

The second device can determine the direction of the first device relative to the second device by any number of suitable methodologies. For example, the second device can include multiple microphones that are offset from one another. The second device can calculate a time difference between each of the microphones detecting the acoustic alert in step 504 in order to determine a direction of origination of the acoustic alert relative to the second device. The second device can calculate a difference in volume level between each of the microphones detecting the acoustic alert in step 504 in order to determine a direction of origination of the acoustic alert relative to the second device. Environmental conditions such as obstructions, surface types, and the like can affect the propagation of sound waves, and the second device can use any known conditions to better estimate the direction of the first device relative to the second.

The second device can determine any landmarks, routes, or the like between the second device and the first device based on GPS, maps, and the like. In some examples, the second device can include sensors to detect obstructions between the second device and the first device, such as radar, LiDAR, or the like. Instructions for responding to the user of the first device or the surroundings of the first device can be generated based on any information about the first device, the user of the first device, the surroundings of the first device, an emergency signal sent by the first device, and the like. The second device can search internal or external databases for advice on how to respond to situations present at the first device, such as a medical emergency, an environmental emergency, or the like.

The method 500 can be used to provide location and tracking services for electronic devices, even when the electronic devices are located in areas that do not have access to network services, such as cellular networks, Wi-Fi networks, and the like. The method 500 can be used by the user of the first device to signal for help, and for others to locate the first device and the user thereof.

The method 500 can include optional steps before step 502. For example, the user of the first device can use the first device to send a satellite SOS signal in order to report an emergency or otherwise call for help. The satellite SOS signal can provide general information as to the user's location, such as within about 50 feet of the user's actual location or the like. Other electronic devices can actively search for the first electronic device based on the satellite SOS signal. The method 500 can further include steps to determine an exact location of the first device. For example, once the second device is within a certain range of the first device, ultra-wideband communication or the like can be used to determine a precise location of the first device.

FIG. 6 illustrates a method 600 of using a first electronic device to guide a second electronic device to the first electronic device. The first electronic device and the second electronic device can alternatively be referred to as a first device and a second device, respectively. The first device and the second device can be similar to or the same as the electronic devices 100, 200, 300, 400 discussed above with respect to FIGS. 1A through 4B. In step 602, a first acoustic alert is generated. The first acoustic alert can be similar to or the same as the acoustic alert generated at step 502 and discussed above in reference to FIG. 5. The first acoustic alert can be generated by a speaker of the first device. The first acoustic alert can be generated in response to a command by a user of the first device, automatically in response to a triggering event (discussed below with respect to FIG. 7), or the like. The triggering event can include a user condition meeting a threshold value (e.g., a detected health condition, a detected accident, or the like), an environmental condition meeting a threshold value (e.g., a detected environmental change, emergency, or disaster), a received signal meeting a threshold value (e.g., receiving a signal reporting an emergency or disaster in proximity to the first device), or the like.

In the method 600, the first acoustic alert can be generated in step 602 by the first device in order to call for rescue, in order to search for another device in need of rescue, or the like. In other words, the first acoustic alert can be generated by a rescuer or a victim. In either case, the first acoustic alert can be generated periodically, in order to conserve battery life in the first device. The first acoustic alert can include audio or encoded messages with information such as a status of a user of the first device, a status of an environment surrounding the first device, a status of an environment surrounding the second device (e.g., to warn a user of the second device of conditions in their surroundings), information related to a signal received by the first device, or the like.

In step 604, a second acoustic alert is detected. The first device can detect a second acoustic alert generated by the second device. The second acoustic alert can be generated by another electronic device, such as the second device. The second acoustic alert can be generated in response to the second device detecting the first acoustic alert generated by the first device in step 602. The second acoustic alert can be similar to or the same as the acoustic alert generated at step 502 and discussed above in reference to FIG. 5. The second acoustic alert can be generated automatically in response to the second device detecting the first acoustic alert, or can be generated in response to an action by a user of the second device subsequent to the second device detecting the second acoustic alert.

In examples in which the first device generates the first acoustic alert to call for rescue, the second acoustic alert can include messages with information including instructions to the user of the first device, an estimated time of arrival for rescuers to the position of the first device, and the like. In examples in which the first device generates the first acoustic alert to search for a device in need of rescue, the second acoustic alert can include messages with information including a status of the user of the second device, a status of an environment surrounding the second device, or the like.

In step 606, a third acoustic alert is detected. The first device can generate a third acoustic alert in response to detecting the second alert in step 604. The third alert can be similar to or the same as the acoustic alert generated at step 502 and discussed above in reference to FIG. 5. The third acoustic alert can be generated more frequently relative to the first alert, as the second device has been detected and battery life conservation is less important. In examples in which the first device generates the first acoustic alert to call for rescue, the third acoustic alert can include messages with information including a status of the user of the first device, a status of an environment surrounding the first device, or the like. In examples in which the first device generates the first acoustic alert to search for a device in need of rescue, the third acoustic alert can include messages with information including instructions to the user of the second device, an estimated time of arrival for rescuers to the position of the second device, and the like.

The method 600 can be used to provide location and tracking services for electronic devices, even when the electronic devices are located in areas that do not have access to network services, such as cellular networks, Wi-Fi networks, and the like. The method 600 can be used to conserve power in a device used to call for rescue. The method 600 can be used by electronic devices used to call for rescue and electronic devices used to search for other electronic devices in need of rescue. The method 600 can provide an acoustic handshake between electronic devices.

FIG. 7 illustrates a method 700 of triggering an alert (e.g., an acoustic alert, as discussed herein) with an electronic device. The electronic device can be similar to or the same as the electronic devices 100, 200, 300, 400 discussed above with respect to FIGS. 1A through 4B. In step 702, the electronic device monitors a signal. The signal can be produced by an internal sensor of the electronic device, an external sensor connected to the electronic device, another electronic device, or the like. In some examples, the electronic device can combine signals received from multiple sources.

The internal sensors can include temperature sensors, microphones, heart rate sensors, accelerometers, gyroscopes, optical sensors, and the like. The internal sensors can be used to monitor vital signs of the user of the electronic device, environmental conditions surrounding the electronic device, and the like. The external sensors can include vital sign sensors (e.g., a glucose sensor, a hear rate monitor, a blood pressure monitor, and the like), environmental sensors (e.g., seismic sensors, radar detectors, flood sensors, wildfire sensors, and the like), and the like. The external sensors and/or other electronic devices can be connected to the electronic device through network communications (e.g., cellular networks, Wi-Fi networks or the like), other wireless connections (e.g., Bluetooth, ZigBee, Wireless USB, Near-Field Communication (NFC)), wired connections, or the like.

In step 704, the electronic device determines whether the monitored signal meets a threshold of a triggering event. The triggering event can include a user condition meeting a threshold value (e.g., a detected health condition, a detected accident, or the like), an environmental condition meeting a threshold value (e.g., a detected environmental change, emergency, or disaster), a received signal meeting a threshold value (e.g., receiving a signal reporting an emergency or disaster in proximity to the first device), or the like. When the threshold of step 704 is met, the electronic device determines that a triggering event is detected and the method 700 proceeds to step 706.

In some examples, the threshold of the triggering event is based on a user condition. The user condition can include a health status, a position or movement, or the like. The health status of the user can be determined based on sensors (e.g., internal or external sensors) that monitor vital signs of the user of the electronic device. The thresholds based on the user condition can include a blood glucose level, a heart rate, a body temperature, a blood pressure, or the like. The thresholds can indicate that the user is experiencing a medical event. The thresholds can be user-specific, and can depend on the user's age, gender, health, medical history, and the like. The thresholds can be activity-dependent, and can vary based on an activity selected by the user on the electronic device, a user activity detected by the electronic device, or the like.

The position or movement of the user can be determined based on sensors that monitor the position and/or movement of the user and/or the electronic device, such as gyroscopes, accelerometers, or the like. The sensors can be internal or external sensors. The thresholds based on the user condition can include a fall detection, a detection of an undesirable position of the user (e.g., the user has been upside down for a period of time), or the like. The thresholds can be user-specific, and can depend on the user's age, gender, health, medical history, and the like. The thresholds can be activity-dependent, and can vary based on an activity selected by the user on the electronic device, a user activity detected by the electronic device, or the like.

In some examples, the threshold of the triggering event is based on a condition of an environment surrounding the electronic device. In some examples, the condition of the environment surrounding the electronic device can include temperature, weather, a detected emergency or disaster near the electronic device, and the like. For example, the condition of the environment surrounding the electronic device can include an avalanche, a flood, an earthquake, a tornado, or the like. The condition of the environment surrounding the electronic device can be determined based on sensors (e.g., internal or external sensors) that monitor the environment surrounding the electronic device, such as temperature sensors, microphones, inertial measurement units (IMUs), and the like. The thresholds can be based on temperatures, weather events, detected emergencies or disasters in proximity to the electronic device, and the like. For example, the threshold of the triggering event can be met when sounds, temperatures, IMU values, and the like indicate that an emergency siren, an avalanche, an earthquake, a tornado, a flood, or the like has occurred in proximity to the electronic device. The threshold for the triggering event can also depend on a proximity of the electronic device to any detected emergency, disaster, or the like.

In some examples, the threshold of the triggering event is based on a received signal. The received signal can be sent to the electronic device from another electronic device or the like. The received signal can be received by the electronic device through wired or wireless communication, including by decoding an acoustic alert, as described herein. The received signal can indicate that a weather event, an emergency, a disaster, or the like has occurred, and can indicate a proximity or location of the event relative to the electronic device. The threshold of the triggering event can be met based on a severity of the event and a proximity of the event to the electronic device.

In step 706, an alert is generated in response to the triggering event of step 704. The alert can be an auditory alert generated by a speaker of the electronic device. The alert can be similar to or the same as the acoustic alert generated at step 502 and discussed above in reference to FIG. 5. As discussed herein, the alert can be an acoustic alert that can be audible to humans, other animals, and/or microphones of other electronic devices that are located within a range of the electronic device.

In some examples, the alert can be generated when the electronic device is outside a network area (e.g., when the electronic device is not connected to a cellular network, a Wi-Fi network, or the like), and a different type of alert can be generated when the electronic device is inside a network area (e.g., when the electronic device is connected to a cellular network, a Wi-Fi network, or the like). However, the alert can be generated regardless of whether the electronic device is inside or outside of a network area.

In some examples, the electronic device can generate the alert automatically in response to the electronic device determining that the threshold of a triggering event has been met. For example, when a user condition meets the threshold of the triggering event under step 704, such as the user being unconscious, the electronic device can automatically generate the alert of step 706. In some examples, the electronic device can provide a notification to the user in response to the electronic device determining that the threshold of the triggering event has been met. The user can command the electronic device to generate or not generate the alert in response to the notification. The electronic device can automatically generate the alert based on the user not responding to the notification within a prescribed time.

The method 700 can be used to provide location and tracking services for electronic devices, even when the electronic devices are located in areas that do not have access to network services, such as cellular networks, Wi-Fi networks, and the like. The various triggering events of the method 700 can be used to generate alerts, either automatically or through input from a user of an electronic device, based on a user condition, an environmental condition, a received signal meeting, or the like.

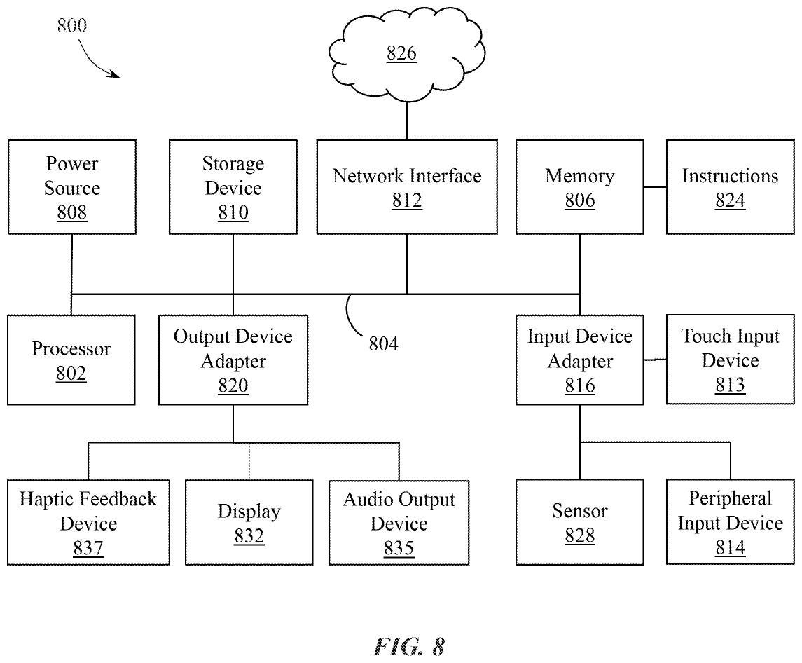

FIG. 8 shows a block diagram of a computing system 800 that can be used to implement embodiments of the present disclosure. In various embodiments, the computing system 800 can include various sets and subsets of the components shown in FIG. 8. Thus, FIG. 8 shows a variety of components that can be included in various combinations and subsets based on the operations and functions performed by the computing system 800 in different embodiments. For example, the computing system 800 can be part of the electronic devices 100, 200, 300, 400 discussed above with respect to FIGS. 1A through 4B and can be used to perform the methods 500, 600, 700 described above with respect to FIGS. 5 through 7. It is noted that, when described or recited herein, the use of the articles such as “a” or “an” is not considered to be limiting to only one, but instead is intended to mean one or more unless otherwise specifically noted herein.

The computing system 800 can include a central processing unit (CPU) or processor 802 connected via a bus 804 for electrical communication to a memory 806, a power source 808, an electronic storage device 810, a network interface 812, an input device adapter 816, and an output device adapter 820. One or more of these components can be connected to each other via a substrate (e.g., a printed circuit board or other substrate) supporting the bus 804 and other electrical connectors providing electrical communication between the components. The bus 804 can include a communication mechanism for communicating information between the components of the computing system 800.

The processor 802 can be a microprocessor or similar device configured to receive and execute a set of instructions 824 stored by the memory 806. The memory 806 can be referred to as a main memory, such as a random access memory (RAM) or another dynamic electronic storage device for storing information and instructions to be executed by the processor 802. The memory 806 can also be used for storing temporary variables or other intermediate information during execution of instructions by the processor 802. The processor 802 can include one or more processors or controllers, such as, for example, a CPU for the computing system 800 in general and a touch controller or similar sensor or I/O interface used for controlling and receiving signals from a display 832 and any other sensors being used (e.g., the microphones 312, 314, 316, or other microphones of the electronic devices 100, 200, 300, 400). The power source 808 can include a power supply capable of providing power to the processor 802 and other components connected to the bus 804, such as a connection to an electrical utility grid (e.g., a wired power supply) or a battery system.

The storage device 810 can include a read-only memory (ROM) or another type of static storage device coupled to the bus 804 for storing static or long-term (e.g., non-dynamic) information and instructions for the processor 802. For example, the storage device 810 can include a magnetic or optical disk (e.g., hard disk drive (HDD)), a solid state memory (e.g., a solid state disk (SSD)), or a comparable device.

The instructions 824 can include information for executing processes and methods using components of the computing system 800. Such processes and methods can include, for example, the methods described in connection with other embodiments elsewhere herein, including, for example, the methods and processes described in connection with FIGS. 4 through 7.

The network interface 812 can comprise an adapter for connecting the computing system 800 to an external device via a wired or wireless connection. For example, the network interface 812 can provide a connection to a computer network 826 such as a cellular network, the Internet, a local area network (LAN), a separate device capable of wireless communication with the network interface 812, other external devices or network locations, and combinations thereof. In one example embodiment, the network interface 812 is a wireless networking adapter configured to connect via WI-FI(R), BLUETOOTH(R), BLE, Bluetooth mesh, or a related wireless communications protocol to another device having interface capability using the same protocol. In some embodiments, a network device or set of network devices in the network 826 can be considered part of the computing system 800. In some cases, a network device can be considered connected to, but not a part of, the computing system 800.

The input device adapter 816 can be configured to provide the computing system 800 with connectivity to various input devices such as, for example, a touch input device 813 (e.g., the display assemblies 106, 226 or the display 328), a peripheral input device 814, one or more sensors 828 (e.g., the microphones 312, 314, 316, or other microphones of the electronic devices 100, 200, 300, 400), related devices, and combinations thereof. The sensors 828 can be used to detect various characteristics of alerts in the vicinity of the computing system 800 (e.g., sound waves and the like) and convert those phenomena to electrical signals. The peripheral input device 814 (e.g., buttons or switches) can be used to provide user input such as input regarding the settings of the computing system 800.

The output device adapter 820 can be configured to provide the computing system 800 with the ability to output information to a user, such as by providing visual output using one or more displays 832, by providing audible output using one or more speakers 835, or providing haptic feedback sensed by touch via one or more haptic feedback devices 837. Other output devices can also be used. The processor 802 can be configured to control the output device adapter 820 to provide information to a user via the output devices connected to the output device adapter 820. In some embodiments, the processor 802 and/or output device adapter 820 can be used to both generate alerts through the speakers of the computing system 800 and provide information to a user based on an alert that is detected through microphones of the computing system 800, as discussed in connection with FIGS. 1A through 7.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, social media ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood- associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. An electronic device comprising:
a sensor configured to generate a signal;
a speaker configured to generate an auditory alert;
a processor in electronic communication with the sensor and the speaker; and
a memory device in electronic communication with the processor, the memory device comprising electronic instructions encoded thereon which, when executed by the processor, cause the processor to perform a method comprising:
monitoring the signal;
determining whether the signal meets a threshold; and
generating the auditory alert in response to the signal meeting the threshold and the electronic device being outside a network area.

2. The electronic device of claim 1, wherein the speaker is configured to generate the auditory alert at a frequency detectable by a human ear or a microphone at 600 ft.

3. The electronic device of claim 1, wherein a value of the threshold varies based on an activity type selected for the electronic device or based on a health condition of a user of the electronic device.

4. The electronic device of claim 1, wherein the sensor is configured to monitor at least one of a vital sign, a movement, a position, or an orientation of a user of the electronic device.

5. The electronic device of claim 1, wherein the sensor is configured to monitor an environment surrounding the electronic device.

6. The electronic device of claim 1, wherein the auditory alert comprises an audible or encoded message comprising information corresponding to a condition of the electronic device or a user of the electronic device.

7. The electronic device of claim 1, wherein the auditory alert is generated automatically in response to the signal meeting the threshold of the triggering event or is generated in response to a user action subsequent to the signal meeting the threshold of the triggering event.

8. An electronic device comprising:
a microphone;
a display;
a processor in electronic communication with the microphone and the display; and
a memory in electronic communication with the processor, the memory comprising electronic instructions encoded thereon which, when executed by the processor, cause the processor to perform a method comprising:
detecting an auditory alert with the microphone; and
based on the detected auditory alert, displaying a notification on the display indicating an origination direction of the auditory alert relative to the electronic device.

9. The electronic device of claim 8, wherein:
the microphone comprises a plurality of microphones; and
the method further comprises determining the origination direction of the auditory alert relative to the electronic device based on a timing of the plurality of microphones detecting the auditory alert.

10. The electronic device of claim 8, wherein the method further comprises displaying a notification on the display indicating a distance between an origination of the auditory alert and the electronic device.

11. The electronic device of claim 10, wherein the method further comprises determining the distance between the origination of the auditory alert and the electronic device based on a volume level of the auditory alert detected by the microphone.

12. The electronic device of claim 10, wherein the method further comprises determining the distance between the origination of the auditory alert and the electronic device based on frequencies of the auditory alert detected by the microphone.

13. The electronic device of claim 8, wherein the method further comprises displaying directions on the display of the electronic device to locate an origination of the auditory alert in response to detecting the auditory alert.

14. The electronic device of claim 8, wherein:
the detected auditory alert comprises an encoded message;
the method further comprises decoding the encoded message; and
the encoded message comprises at least one of location data of another electronic device, status data of a user of the other electronic device, status data of an environment of the other electronic device, or instructions to be performed by a user of the electronic device.

15. A method comprising:
generating a first auditory alert with a first device;
detecting a second auditory alert with the first device; and
in response to detecting the second auditory alert, generating a third auditory alert with the first device different from the first auditory alert.

16. The method of claim 15, wherein at least one of the first auditory alert, the second auditory alert, or the third auditory alert comprises an audible message or an encoded message.

17. The method of claim 16, wherein the audible message or the encoded message comprises at least one of location data of the first device or a second device, status data of a status of a user of the first device or the second device, status data of an environment surrounding the first device or the second device, or instructions to be performed by the user of the first device or the second device.

18. The method of claim 15, wherein the second auditory alert is generated by a second device in response to the second device detecting the first auditory alert.

19. The method of claim 15, wherein the first auditory alert is generated with less power relative to the third auditory alert.

20. The method of claim 15, further comprising performing digital signal processing with the first device to optimize detection of the second auditory alert.
